(19) United States
(12) Patent Application Publication
(10) Pub. No.: US 2026/0303612 A1
(43) Pub. Date: Oct. 1, 2026

(54) Time Controlled Shut Down of Switch Ports to Prevent Security Incidents

(71) Applicant: Arista Networks, Inc., Santa Clara, CA (US)

(72) Inventors: Rishabh Kumar PODDAR, Bengaluru (IN); Manish SINGHVI, Bengaluru (IN)

(21) Appl. No.: 19/090,902

(22) Filed: Mar. 26, 2025

(51) Int. Cl. H04L 9/40

(52) U.S. Cl. CPC H04L 63/108; H04L 63/0876

(57) ABSTRACT

The RADIUS (Remote Authentication Dial In User Service) protocol is used to authenticate user devices, for example, to gain access to a port on the edge device of a network. When malicious or suspected malicious activity is detected, the RADIUS server transmits a CoA (change of authentication) message to the edge device. The CoA message includes an attribute that informs the edge device to shut down the port. The attribute can specify a temporary shut down of the port with a specified duration or a permanent shut down of the port. Shutting down the port serves to disconnect that user device from the port, thus terminating communication between the user device and the edge device.

### BACKGROUND

The present disclosure relates to switch port management using the RADIUS (Remote Authentication Dial In User Service) protocol. RADIUS is generally used to manage user authentication, authorization, and accounting for network access. The protocol verifies user credentials before allowing the user's device to connect to a network and controls what services the user can access once logged in. RADIUS allows network administrators to control user access to resources based on policies and permissions.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is an example of a communication system illustrating aspects of the present disclosure.

FIG. 2 is an example message sequence chart illustrating an authentication sequence.

FIG. 3 is an example flow of operations in accordance with the present disclosure.

FIG. 4 is an example message sequence chart illustrating a change of authentication sequence in accordance with the present disclosure.

FIG. 5 is an example of a network device in some embodiments.

### DETAILED DESCRIPTION

The present disclosure relates to switch port management using a RADIUS authentication server. More particularly, the present disclosure utilizes the RADIUS CoA (Change of Authorization) message to temporarily shut down a port for a specified duration of time. This capability can be used when malicious activity is suspected on the port or other security-related matter arises to disable the port and initiate remedial action.

An example workflow in accordance with some embodiments proceeds as follows:
A user device (supplicant) connects to an interface (physical or logical) on the switch (network device). The user device can be connected directly to a physical port on the switch or to a logical interface configured on the physical port.
The switch authenticates the user device by sending an access request to the RADIUS server containing an identifier of the user device. In some embodiments, the switch can use the MAC (media access control) address of the user device as the identifier of the user device. In other embodiments, the switch can use the EAPOL (Extensible Authentication Protocol over LAN) protocol to obtain information that identifies the user device. It will be appreciated that, in general, any suitable session identification mechanism can be used.
The RADIUS server sends an access accept response to the switch, and the switch in response configures the port to allow the user device to communicate over the port. In addition, the switch can program the MAC address of the user device in its FIB (forwarding information base) so that traffic from the user device can be processed and forwarded.
The RADIUS server is signaled when a security issue associated with the port is detected. In accordance with the present disclosure, the RADIUS server will send a CoA message to the switch. The attribute field of the CoA message will include a RADIUS VSA (vendor-specific attribute) comprising an integer value equal to time, e.g., expressed in seconds, for which the port needs to be shut down.
In response, the switch shuts down the port, for example by “error disabling” the port, and initiates an internal timer that runs for a period of time based on the shutdown duration. In addition, the switch will remove the MAC address of the user device from its FIB. Shutting down the port terminates communication with the user device, forcing the user device to disconnect, re-connect, and re-authenticate with the switch. Moreover, because the port is down the user device cannot authenticate with the switch, and more generally the switch will not authenticate any user device that connects to the port.
Upon expiration of the internal timer, the switch will bring up the port to re-enable the port. Any user device that is connected to the switch can must be re-authenticated.
Although embodiments of the present disclosure are explained using CoA messaging, it will be appreciated that other RADIUS messages may be adapted to provide the same capability of shutting down a port in accordance with the present disclosure.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

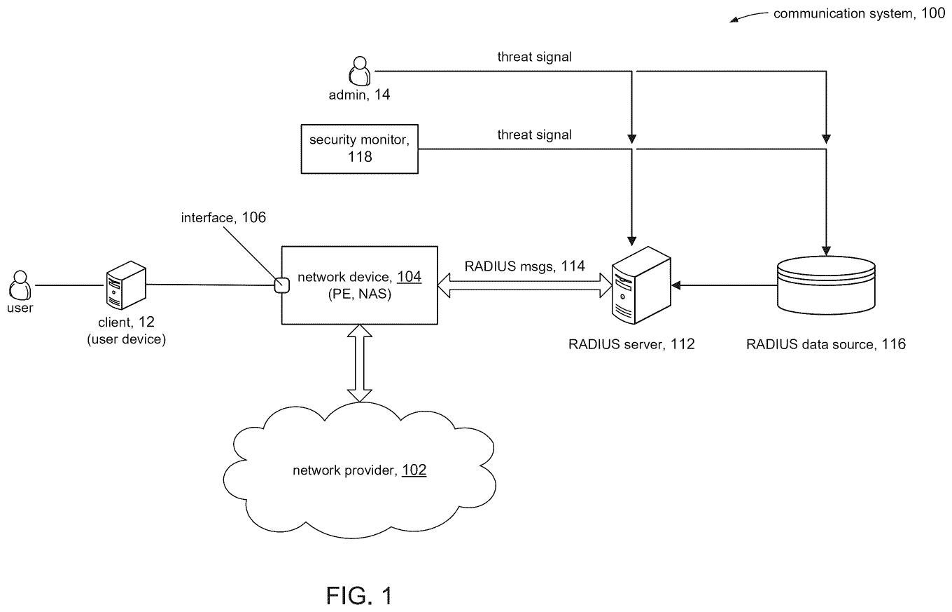

FIG. 1 is a high-level diagram illustrating an example communication system that can embody the techniques in accordance with the present disclosure. In some embodiments, for example, communication system 100 includes network provider 102 that can provide services to a user via client device 12 (e.g., laptop computer, mobile device, etc.). Services can include, but are not limited to, data access services (data centers, cloud storage, etc.), video services (streaming, conferencing, etc.), access to an enterprise, and so on. Network device 104 can be an edge device on network provider 102 (referred to as a provider edge, PE, device) that allows access to the network provider. In the context of the RADIUS (Remote Authentication Dial In User Service) protocol, network device 104 can also be referred to as a NAS (Network Access Server).

Client device 12 connects to network device 104 to access network provider 102. More specifically, client device 12 connects to interface 106 on network device 104. In some embodiments, interface 106 can be the physical port itself on network device 104. In other embodiments, interface 106 is a logical interface defined on a physical port on network device 104; e.g., client device 12 can be connected to interface 106 via a hub (not shown).

In accordance with the present disclosure, network device 104 can grant or deny client device 12 access to interface 106. Network device 104 communicates with RADIUS server 112 to access authentication services provided by the RADIUS server to authenticate the client device. RADIUS messages 114 are exchanged to carry out an authentication sequence between network device 104 and RADIUS server 112. RADIUS data source 116 includes information such as user identification, certificates, credentials, interface configurations, and so on that RADIUS server 112 uses to authenticate client device 12. RADIUS data source 116 can be a database maintained by RADIUS server 112, or a separate data service that the RADIUS server communicates with.

Network administrator 14 can signal RADIUS server 112 and/or RADIUS data source 116 when the network administrator is notified or otherwise becomes aware of suspicious or potential malicious activity. Likewise, security monitoring system 118 can monitor the flow of traffic in network provider 102 and signal RADIUS server 112 and/or RADIUS data source 116 when malicious/suspicious activity in the traffic is detected. It will be appreciated that other sources (not shown) can identify security-related issues and signal RADIUS server 112 and/or RADIUS data source 116 when such issues are detected.

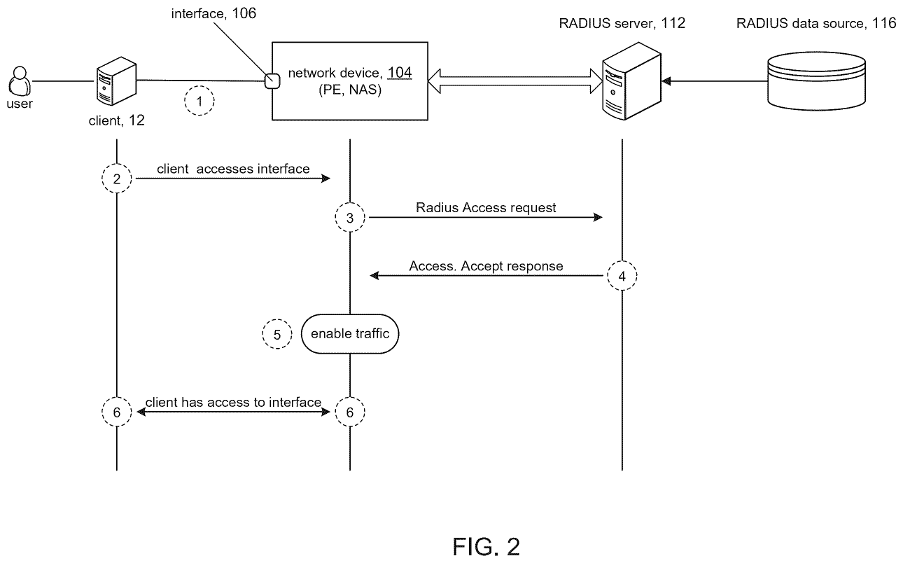

FIG. 2 illustrates an example authentication sequence in accordance with the RADIUS protocol to authenticate client device 12 and grant or deny the client device access to interface 106. The circled indicators are time references:
At time 1, a user connects client device 12 to interface 106 on network device 104. As noted above, interface 106 can be a physical port that client device 12 is directly plugged into, or interface 106 can be a logical port that client device 12 connects to via a hub (not shown).
At time 2, client device 12 can begin communicating with network device 104 by sending packets to the network device. Network device 104 can obtain an identifier that identifies client device 12. In some embodiments, for example, the MAC (media access control) address of client device 12 contained in packets sent to network device 104 can serve to identify the client device. In other embodiments, client device 12 and network device 104 can use the EAPOL protocol (Extensible Authentication Protocol over LAN) to obtain the client device's ID.
At time 3, network device 104 makes a RADIUS Access request to RADIUS server 112 using the client device ID. RADIUS server 112 can access information from RADIUS data source 116 to verify the client device ID to determine whether to grant or deny access to client device 12.
At time 4, assuming for discussion purposes that the identity of client device 12 is verified, RADIUS server 112 sends an Access Accept response to network device 104.
At time 5, in response to receiving the Access Accept response from RADIUS server 112, network device 104 configures interface 106 to allow client device 12 to communicate on the interface. In addition, network device 104 can program the MAC address of client device 12 in its FIB (forwarding information base) so that traffic from the client can be processed.
At time 6, client device 12 and network device 104 can communicate with each other over interface 106.

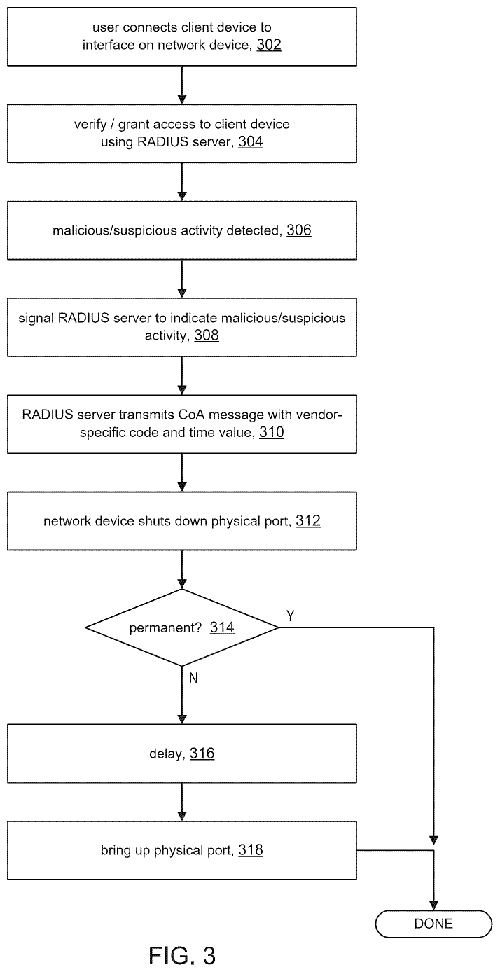

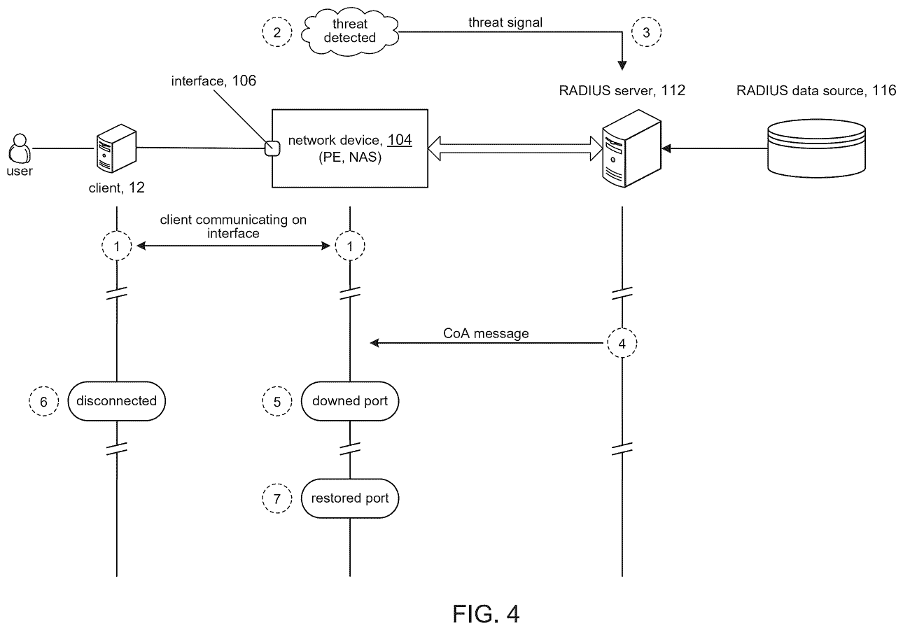

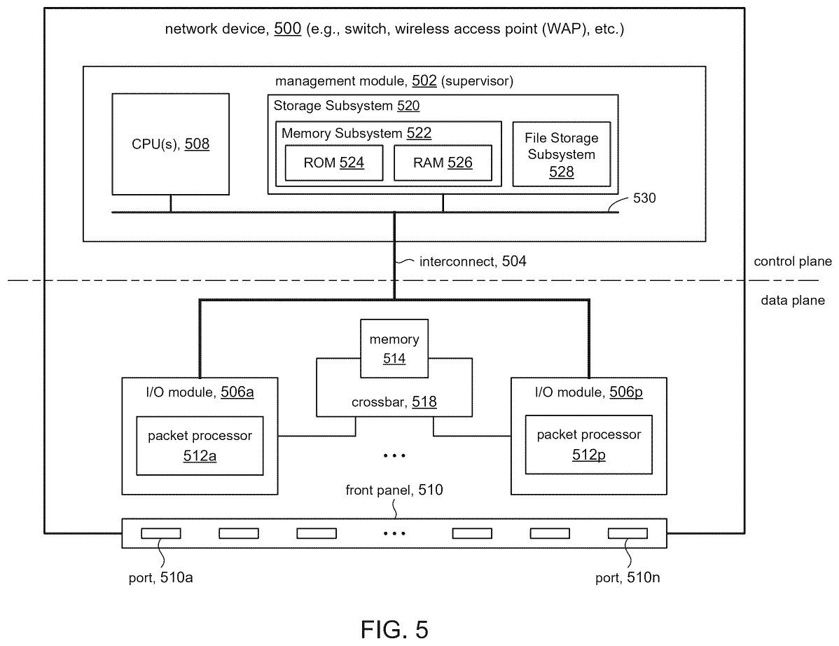

Referring to FIG. 3 and the message sequence charts in FIGS. 2 and 4, the discussion will now turn to a high-level description of processing to protect a port on a network device (e.g., 104) against potential security issues in accordance with the present disclosure. Depending on a given implementation, the processing may be performed entirely in the control plane or entirely in the data plane of the network device, or the processing may be divided between the control plane and the data plane. In some embodiments, the network device can include one or more processing units (circuits), which when operated, can cause the network device to perform processing in accordance with FIG. 3. Processing units (circuits) in the control plane, for example, can include general CPUs that operate by way of executing computer program code stored on a non-volatile computer readable storage medium (e.g., read-only memory); e.g., CPU 508 in the control plane (FIG. 5) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 512a-512p in the data plane (FIG. 5) can be a specialized processor.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

At operation 302, a user can connect their client device (e.g., 12, FIG. 1) to an interface (e.g., 106) on the network device. As noted above, the interface can refer to the physical port on the network device to which the client device is connected, or the interface can be a logical interface defined on the physical port.

At operation 304, the network device can verify the client device with a server (e.g., RADIUS server 112) in accordance with the RADIUS protocol. An authentication example is shown by the sequence of RADIUS messages in FIG. 2. Assuming for discussion purposes that access is granted (i.e., the client ID of the client device is verified), the client device can commence communication with the network device. Referring to the message sequence example of FIG. 4, this initial condition is shown at time 1 (circled number).

At operation 306, for discussion purposes, malicious/suspicious activity is detected in connection with the interface to which the client device is connected (FIG. 4, time 2). For example, a security monitoring system (e.g., 118) may detect suspicious activity in the network traffic. Network administrator 14 may become aware of suspicious activity, and so on.

At operation 308, the RADIUS server can be signaled in response to the detection of potential malicious activity. For example, the monitoring system or a network administrator can signal the RADIUS server (FIG. 4, time 3).

At operation 310, the network device can receive a CoA (change of authorization) message from the RADIUS server (FIG. 4, time 4). In accordance with some embodiments, the CoA message comprises a standard RADIUS header including a Code (set to 43 for CoA request), Identifier, Length, Authenticator, and a shutdown attribute expressed in TLV (type, length, value) format to shut down the port. For instance, RADIUS defines an attribute, referred to as VSA (vendor-specific attribute), that can comprise one or more sub-attributes. The VSA allows vendors to support their own extended attributes. The VSA includes a string field that can encode one or more sub-attributes. In some embodiments, for example, the shutdown attribute can be a sub-attribute in the VSA that contains the following information:
Shutdown-Code, ID, Duration
   where Shutdown-Code—this is information (e.g., an integer value) that is interpreted by the network device to shut down a port. In a use case where there is a single sub-attribute, the code can be omitted.
ID—this is an identifier that can be used to determine which port to shut down,
Duration—this is a duration (e.g., in seconds, expressed as a 32-bit value) that the port is to be shut down.
   In various embodiments, ID can be any suitable attribute that the network device can use to identify the port to shut down. For example, the identifier can identify the user that is connected to the port (e.g., user name, calling station ID, account session ID, etc.) or an identifier of the port itself. In some embodiments, Duration can be set to 0xFFFFFFFF to inform the network device to permanently shut down the port, requiring a network administrator to manually bring up the port. The duration, whether temporary or permanent, can be specified by a user; e.g., network administrator 14.

At operation 312, the network device can shut down the physical port to disable or otherwise prevent communication with any device connected to the port (FIG. 4, time 5). In some embodiments, for example, the network device typically includes functionality that can be invoked by a network administrator to shut down individual ports, for example, for maintenance purposes. In accordance with the present disclosure, the network device can invoke that shutdown functionality in response to receiving a CoA message from the RADIUS server containing the shutdown attribute described above. Further in accordance with the present disclosure, the network device can remove the MAC address of the client device that is connected to the port from its FIB. This has the effect of forcing the client device to re-authenticate with the network device.

Shutting down the port terminates communication with the client device (FIG. 4, time 6), forcing the client device to disconnect, re-connect, and re-authenticate with the network device. Moreover, because the port is down the network will not authenticate the client device, and more generally will not authenticate any device that connects to the port. This effectively blocks any further potential malicious activity emanating from the client device.

At decision point 314, if the Duration parameter of the shutdown attribute indicates permanent shutdown (e.g., Duration=0xFFFFFFFF), then processing can be deemed complete (DONE). The port will have to be manually brought up, for example, by the network administrator. On the other hand, if the Duration parameter of the shutdown attribute indicates a temporary shutdown, then processing can proceed to operation 316.

At operation 316, the network device can bring up the port after delaying for at least the period of time specified by the Duration parameter of the shutdown attribute; for example by setting a timer.

At operation 318, the network device can bring up the downed port after expiration of the timer (FIG. 4, time 7). If a device is connected to the port, the device will have to be re-authorized, for example. per the sequence shown in FIG. 2. Processing can be deemed complete (DONE).

The present disclosure is particularly useful in a large deployment where human response times to potential or actual attacks is too slow. Embodiments in accordance with the present disclosure allow for automated security monitoring systems to monitor the traffic and the deployment, and to immediately shut down ports where suspected activity is present.

FIG. 5 is a schematic representation of a network device 500 (e.g., switch, wireless access point, etc.) that can be adapted in accordance with the present disclosure. In some embodiments, for example, network device 500 can include one or more management modules 502, one or more I/O modules (switches, switch chips) 506a-506p, and a front panel 510 of I/O ports (physical interfaces, I/Fs) 510a-510n. Management module 502 can constitute the control plane of network device 500 (also referred to as the control layer or simply the central processing unit, CPU), and can include CPU(s) 508 for managing and controlling operation of network device 500 in accordance with the present disclosure. CPU(s) 508 can be a general-purpose processor, such as an Intel®/AMD® x86, ARM® microprocessor and the like, that operates under the control of software stored in a memory device/chips such as read-only memory (ROM) 524 or random-access memory (RAM) 526. The control plane provides services that include traffic management functions such as routing, security, load balancing, analysis, and the like.

CPU(s) 508 can communicate with storage subsystem 520 via bus subsystem 530. Other subsystems, such as a network interface subsystem (not shown in FIG. 5), may be on bus subsystem 530. Storage subsystem 520 can include memory subsystem 522 and file/disk storage subsystem 528. Memory subsystem 522 and file/disk storage subsystem 528 represent examples of non-transitory computer-readable storage devices that can store program code and/or data, which when executed by CPU(s) 508, can cause CPU(s) 508 to perform operations in accordance with embodiments of the present disclosure.

Memory subsystem 522 can include a number of memories such as main RAM 526 (e.g., static RAM, dynamic RAM, etc.) for storage of instructions and data during program execution, and ROM (read-only memory) 524 on which fixed instructions and data can be stored. File storage subsystem 528 can provide persistent (i.e., non-volatile) storage for program and data files, and can include storage technologies such as solid-state drive and/or other types of storage media known in the art.

CPU(s) 508 can run a network operating system stored in storage subsystem 520. A network operating system is a specialized operating system for network device 500. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 530 can provide a mechanism for the various components and subsystems of management module 502 to communicate with each other as intended. Although bus subsystem 530 is shown schematically as a single bus, alternative embodiments of the bus subsystem can utilize multiple buses.

The one or more I/O modules 506a-506p can be collectively referred to as the data plane of network device 500 (also referred to as the data layer, forwarding plane, etc.). Interconnect 504 represents interconnections between modules in the control plane and modules in the data plane. Interconnect 504 can be any suitable bus architecture such as Peripheral Component Interconnect Express (PCIe), System Management Bus (SMBus), Inter-Integrated Circuit (I²C), etc.

I/O modules 506a-506p can include respective packet processing hardware comprising packet processors 512a-512p (collectively 512) to provide packet processing and forwarding capability. Each I/O module 506a-506p can be further configured to communicate over one or more ports 510a-510n on the front panel 510 to receive and forward network traffic. Packet processors 512 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 512 can include forwarding lookup hardware such as, for example, but not limited to content addressable memory such as ternary CAMs (TCAMs) and auxiliary memory such as static RAM (SRAM).

Memory hardware 514 can include buffers used for queueing packets. I/O modules 506a-506p can access memory hardware 514 via crossbar 518. It is noted that in other embodiments, the memory hardware 514 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device for securing a port on the network device, the method comprising:
detecting connection of a user device to a port on the network device;
obtaining an identifier of the user device;
communicating the identifier of the user device to an authentication server to request an access grant from the authentication server;
receiving an access grant from the authentication server;
configuring the port on the network device for communication with the user device in response to receiving the access grant;
subsequent to configuring the port on the network device for communication with the user device, receiving a change of authorization message from the authentication server, the change of authorization message comprising a port shutdown code and a shutdown duration;
in response to the change of authorization message having the port shutdown code:
shutting down the port, wherein the user device is disconnected from the port, wherein the network device ceases authenticating any user device that connects to the port; and
initiating a timer to run for a period of time based on the shutdown duration; and
in response to expiration of the timer, re-enabling the port to resume authenticating any user device that connects to the port.

2. The method of claim 1, wherein receiving the change of authorization message occurs in response to a detected threat involving the port.

3. The method of claim 1, wherein configuring the port on the network device for communication with the user device includes programming a MAC (media access control) address of the user device in a FIB (forwarding information base) on the network device.

4. The method of claim 3, further comprising in response to the change of authorization message having the port shutdown code, removing the MAC address of the user device from the FIB on the network device to disable communication with the user device.

5. The method of claim 1, wherein the identifier of the user device is a MAC (media access control) address of the user device.

6. The method of claim 1, further comprising obtaining the identifier of the user device using EAPOL (Extensible Authentication Protocol over LAN) protocol.

7. The method of claim 1, wherein the authentication server is a RADIUS (Remote Authentication Dial In User Service) protocol server.

8. A network device comprising:
one or more computer processors; and
a computer-readable storage device comprising instructions for controlling the one or more computer processors to:
authenticate a user device connected to a port on the network device;
in response to the user device being authenticated, configure the port on the network device for communication with the user device;
subsequent to configuring the port on the network device for communication with the user device, receive a first message comprising a port shutdown code that indicates to shutdown the port for a shutdown duration; and
shut down the port based on the shutdown duration, in response to receiving the first message, wherein the user device is disconnected from the port, wherein the network device ceases authenticating any user device that connects to the port.

9. The network device of claim 8, wherein the first message is a change of authorization message.

10. The network device of claim 8, wherein the computer-readable storage device further comprises instructions for controlling the one or more computer processors to communicate with a server using RADIUS (Remote Authentication Dial In User Service) protocol to authenticate the user device.

11. The network device of claim 8, wherein the computer-readable storage device further comprises instructions for controlling the one or more computer processors to:
initiate a timer to run for a period of time based on the shutdown duration; and
in response to expiration of the timer, re-enable the port to resume authenticating any user device that connects to the port.

12. The network device of claim 8, wherein the shutdown duration is a value that indicates to permanently shutdown the port.

13. The network device of claim 8, wherein receiving the first message occurs in response to a detected threat involving the port.

14. The network device of claim 8, wherein the computer-readable storage device further comprises instructions for controlling the one or more computer processors to remove a MAC (media access control) address of the user device from a FIB (forwarding information base) on the network device to disable communication with the user device in response to receiving the first message.

15. A non-transitory computer-readable storage device in a network device, the non-transitory computer-readable storage device having stored thereon computer executable instructions, which when executed, cause the network device to:
authenticate a user device connected to a port on the network device;
in response to the user device being authenticated, configure the port on the network device for communication with the user device;
receive a first message, at a time subsequent to configuring the port on the network device for communication with the user device, wherein the first message comprises a port shutdown code that indicates to shutdown the port for a shutdown duration; and
shut down the port based on the shutdown duration, in response to receiving the first message, wherein the user device is disconnected from the port,
wherein the network device ceases authenticating any user device that connects to the port.

16. The non-transitory computer-readable storage device of claim 15, wherein the computer executable instructions, which when executed, further cause the network device to communicate with a server using RADIUS (Remote Authentication Dial In User Service) protocol to authenticate the user device.

17. The non-transitory computer-readable storage device of claim 15, wherein the computer executable instructions, which when executed, further cause the network device to:
initiate a timer to run for a period of time based on the shutdown duration; and
in response to expiration of the timer, re-enable the port to resume authenticating any user device that connects to the port.

18. The non-transitory computer-readable storage device of claim 15, wherein the shutdown duration is a value that indicates to permanently shutdown the port.

19. The non-transitory computer-readable storage device of claim 15, wherein receiving the first message occurs in response to a detected threat involving the port.

20. The non-transitory computer-readable storage device of claim 15, wherein the computer executable instructions, which when executed, further cause the network device to remove a MAC (media access control) address of the user device from a FIB (forwarding information base) on the network device to disable communication with the user device in response to receiving the first message.
